(19) United States
(12) Patent Application Publication
(10) Pub. No.: US 2015/0244658 A1
(43) Pub. Date: Aug. 27, 2015

(54) SYSTEM AND METHOD FOR EFFICIENTLY MIXING VOIP DATA

(71) Applicant: Talko Inc., Seattle, WA (US)

(72) Inventors: RICHARD ZACK SPEYER, Boston, MA (US); Ransom Lloyd Richardson, Beverly, MA (US); Raymond Edward Ozzie, Seattle, WA (US)

(21) Appl. No.: 14/621,909

(22) Filed: Feb. 13, 2015

Related U.S. Application Data
(60) Provisional application No. 61/943,666, filed on Feb. 24, 2014.

(51) Int. Cl. H04L 12/58

(52) U.S. Cl. CPC H04L 51/066; H04L 51/10

(57) ABSTRACT

A method, computer program product, and computer system for monitoring a communication session between a plurality of users. It is determined whether at least two users of the plurality of users are sending media in the communication session. If only a first user of the plurality of users is sending media, the media is delivered to the plurality of users via a first technique. If the first user and a second user of the plurality of users are sending media, the media is delivered to the plurality of users via a second technique.

### RELATED CASES

This application claims the benefit of U.S. Provisional Application No. 61/943,666 filed on 24 Feb. 2014, the content of which is all incorporated by reference.

### BACKGROUND

Generally, traditional Voice-Over-IP (VoIP) systems may have been built primarily around Peer to Peer (P2P) communication that may have been expected to run over stable broadband internet connections. VoIP conferences may also include N endpoints (e.g., more than two computing devices in the communication session). Some VoIP systems may employ, e.g., a mesh approach, a hub-and-spoke model approach, as well as other approaches. Each of these example approaches may still lead to a less than ideal experience for the user.

### BRIEF SUMMARY OF DISCLOSURE

In one example implementation, a method, performed by one or more computing devices, may include but is not limited to monitoring, by a computing device, a communication session between a plurality of users. It may be determined whether at least two users of the plurality of users are sending media in the communication session. If only a first user of the plurality of users is sending media, the media may be delivered to the plurality of users via a first technique. If the first user and a second user of the plurality of users are sending media, the media may be delivered to the plurality of users via a second technique.

One or more of the following example features may be included. Determining whether the at least two users of the plurality of users are sending media in the communication session may include determining for a predetermined interval of time whether the at least two users of the plurality of users are sending media in the communication session simultaneously. Delivering the media to the plurality of users via the first technique may include delivering a packet containing at least a portion of the media to the plurality of users without decoding and encoding the packet. Delivering the media to the plurality of users via the second technique may include waiting for a predetermined number of time intervals, and may include mixing the media received from the first user and the second user during the predetermined number of time intervals. Sending of the mixed media to the plurality of users may be delayed until after the predetermined number of time intervals. The mixed media may be sent to the plurality of users during a next time interval after the predetermined number of time intervals. The mixed media sent to the plurality of users in the next time interval may include a plurality of time intervals of media contained in a plurality of packets sent during a single time interval. Mixing the media received from the first user and the second user may include excluding the media sent from the first user in the mixed media when delivering the mixed media to the first user. The media may be delivered to the first user and the second user via the first technique when only the first user and the second user are connected to the communication session. Delivering the media to the plurality of users via the second technique may include executing an encode operation for less than each of the plurality of users. Delivering the media to the plurality of users via the second technique may include sending a multi-channel media packet where each channel is a respective user's encoded and encrypted media stream.

In another example implementation, a computing system includes a processor and a memory configured to perform operations that may include but are not limited to monitoring a communication session between a plurality of users. It may be determined whether at least two users of the plurality of users are sending media in the communication session. If only a first user of the plurality of users is sending media, the media may be delivered to the plurality of users via a first technique. If the first user and a second user of the plurality of users are sending media, the media may be delivered to the plurality of users via a second technique.

One or more of the following example features may be included. Determining whether the at least two users of the plurality of users are sending media in the communication session may include determining for a predetermined interval of time whether the at least two users of the plurality of users are sending media in the communication session simultaneously. Delivering the media to the plurality of users via the first technique may include delivering a packet containing at least a portion of the media to the plurality of users without decoding and encoding the packet. Delivering the media to the plurality of users via the second technique may include waiting for a predetermined number of time intervals, and may include mixing the media received from the first user and the second user during the predetermined number of time intervals. Sending of the mixed media to the plurality of users may be delayed until after the predetermined number of time intervals. The mixed media may be sent to the plurality of users during a next time interval after the predetermined number of time intervals. The mixed media sent to the plurality of users in the next time interval may include a plurality of time intervals of media contained in a plurality of packets sent during a single time interval. Mixing the media received from the first user and the second user may include excluding the media sent from the first user in the mixed media when delivering the mixed media to the first user. The media may be delivered to the first user and the second user via the first technique when only the first user and the second user are connected to the communication session. Delivering the media to the plurality of users via the second technique may include executing an encode operation for less than each of the plurality of users. Delivering the media to the plurality of users via the second technique may include sending a multi-channel media packet where each channel is a respective user's encoded and encrypted media stream.

In another example implementation, a computer program product resides on a computer readable storage medium that has a plurality of instructions stored on it. When executed by a processor, the instructions cause the processor to perform operations that may include but are not limited to monitoring a communication session between a plurality of users. It may be determined whether at least two users of the plurality of users are sending media in the communication session. If only a first user of the plurality of users is sending media, the media may be delivered to the plurality of users via a first technique. If the first user and a second user of the plurality of users are sending media, the media may be delivered to the plurality of users via a second technique.

One or more of the following example features may be included. Determining whether the at least two users of the plurality of users are sending media in the communication session may include determining for a predetermined interval of time whether the at least two users of the plurality of users are sending media in the communication session simultaneously. Delivering the media to the plurality of users via the first technique may include delivering a packet containing at least a portion of the media to the plurality of users without decoding and encoding the packet. Delivering the media to the plurality of users via the second technique may include waiting for a predetermined number of time intervals, and may include mixing the media received from the first user and the second user during the predetermined number of time intervals. Sending of the mixed media to the plurality of users may be delayed until after the predetermined number of time intervals. The mixed media may be sent to the plurality of users during a next time interval after the predetermined number of time intervals. The mixed media sent to the plurality of users in the next time interval may include a plurality of time intervals of media contained in a plurality of packets sent during a single time interval. Mixing the media received from the first user and the second user may include excluding the media sent from the first user in the mixed media when delivering the mixed media to the first user. The media may be delivered to the first user and the second user via the first technique when only the first user and the second user are connected to the communication session. Delivering the media to the plurality of users via the second technique may include executing an encode operation for less than each of the plurality of users. Delivering the media to the plurality of users via the second technique may include sending a multi-channel media packet where each channel is a respective user's encoded and encrypted media stream.

The details of one or more example implementations are set forth in the accompanying drawings and the description below. Other features and advantages will become apparent from the description, the drawings, and the claims.

### BRIEF DESCRIPTION OF THE DRAWINGS

FIG. 1 is an example diagrammatic view of a transmission process coupled to a distributed computing network according to one or more example implementations of the disclosure;

FIG. 2 is an example diagrammatic view of a client electronic device of FIG. 1 according to one or more example implementations of the disclosure;

FIG. 3 is an example flowchart of the transmission process of FIG. 1 according to one or more example implementations of the disclosure; and

FIG. 4 is an example diagrammatic view of two example transmission scenarios of the transmission process of FIG. 1 according to one or more example implementations of the disclosure.

Like reference symbols in the various drawings indicate like elements.

### DETAILED DESCRIPTION

### System Overview

As will be appreciated by one skilled in the art, the present disclosure may be embodied as a method, system, or computer program product. Accordingly, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. The computer readable program code may be transmitted using any appropriate medium, including but not limited to the internet, wireline, optical fiber cable, RF, etc. A computer readable signal medium may be any computer readable medium that is not a computer readable storage medium and that can communicate, propagate, or transport a program for use by or in connection with an instruction execution system, apparatus, or device.

Computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGA), micro-controller units (MCUs), or programmable logic arrays (PLA) may execute the computer readable program instructions/code by utilizing state information of the computer readable program instructions to personalize the electronic circuitry, in order to perform aspects of the present disclosure.

The flowchart and block diagrams in the figures illustrate the architecture, functionality, and operation of possible implementations of apparatus (systems), methods and computer program products according to various implementations of the present disclosure. It will be understood that each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some alternative implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

The computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

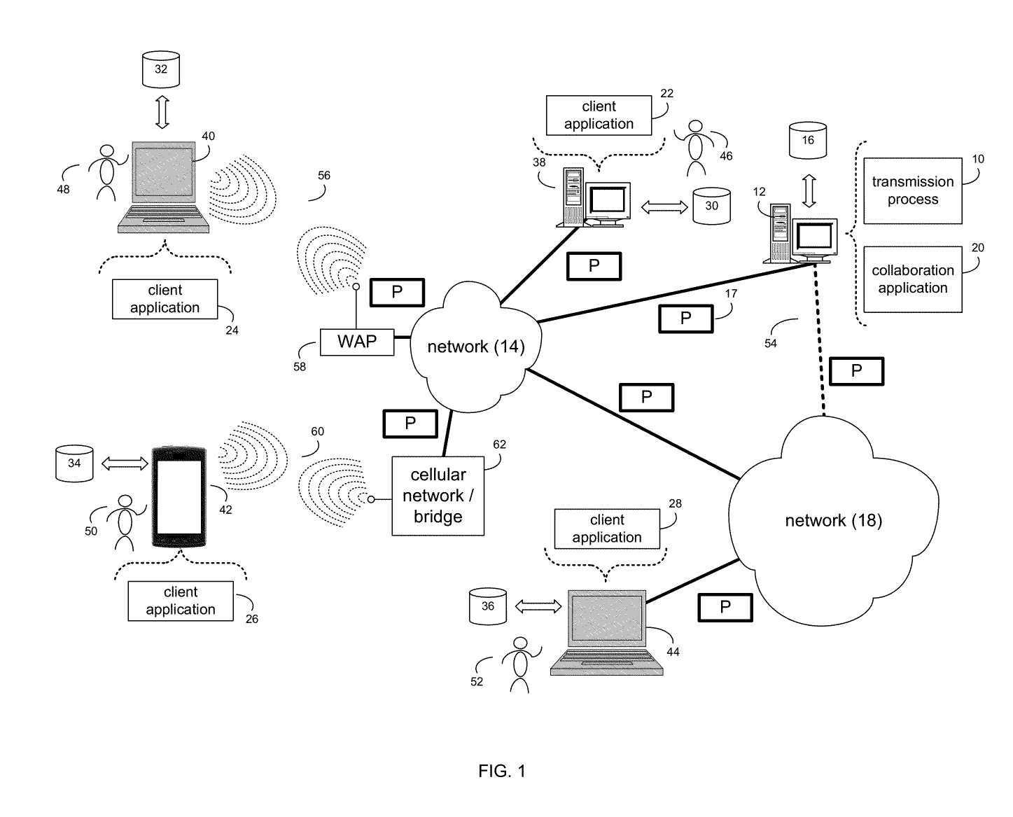

Referring now to FIG. 1, there is shown transmission process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, transmission process 10 may monitor a communication session between a plurality of users. It may be determined whether at least two users of the plurality of users are sending media (e.g., Packet(s) P 17) in the communication session. If only a first user of the plurality of users is sending media, the media may be delivered to the plurality of users via a first technique. If the first user and a second user of the plurality of users are sending media, the media may be delivered to the plurality of users via a second technique.

The instruction sets and subroutines of transmission process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, triplestore database, etc.) and may be located within any suitable memory location, such as storage device 16 coupled to computer 12. Any data described throughout the present disclosure may be stored in the data store. In some implementations, computer 12 may utilize a database management system such as, but not limited to, “My Structured Query Language” (MySQL®) in order to provide multi-user access to one or more databases, such as the above noted relational database. The data store may also be a custom database, such as, for example, a flat file database or an XML database. Any other form(s) of a data storage structure and/or organization may also be used. Transmission process 10 may be a component of the data store, a stand alone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute a collaboration application (e.g., collaboration application 20), examples of which may include, but are not limited to, e.g., a web conferencing application, a video conferencing application, a voice-over-IP application, a video-over-IP application, an Instant Messaging (IM)/“chat” application, short messaging service (SMS)/multimedia messaging service (MMS) application, or other application that allows for virtual meeting and/or remote collaboration. Transmission process 10 and/or collaboration application 20 may be accessed via client applications 22, 24, 26, 28. Transmission process 10 may be a stand alone application, or may be an applet/application/script/extension that may interact with and/or be executed within collaboration application 20, a component of collaboration application 20, and/or one or more of client applications 22, 24, 26, 28. Collaboration application 20 may be a stand alone application, or may be an applet/application/script/extension that may interact with and/or be executed within transmission process 10, a component of transmission process 10, and/or one or more of client applications 22, 24, 26, 28. One or more of client applications 22, 24, 26, 28 may be a stand alone application, or may be an applet/application/script/extension that may interact with and/or be executed within and/or be a component of transmission process 10 and/or collaboration application 20. Examples of client applications 22, 24, 26, 28 may include, but are not limited to, e.g., a web conferencing application, a video conferencing application, a voice-over-IP application, a video-over-IP application, an Instant Messaging (IM)/“chat” application, short messaging service (SMS)/multimedia messaging service (MMS) application, or other application that allows for virtual meeting and/or remote collaboration, a standard and/or mobile web browser, an email client application, a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android′, Apple® iOS®, Mac® OS X®; Red Hat® Linux®, or a custom operating system.

One or more of client applications 22, 24, 26, 28 may be configured to effectuate some or all of the functionality of transmission process 10 (and vice versa). Accordingly, transmission process 10 may be a purely server-side application, a purely client-side application, or a hybrid server-side/client-side application that is cooperatively executed by one or more of client applications 22, 24, 26, 28 and/or transmission process 10.

One or more of client applications 22, 24, 26, 28 may be configured to effectuate some or all of the functionality of collaboration application 20 (and vice versa). Accordingly, collaboration application 20 may be a purely server-side application, a purely client-side application, or a hybrid server-side/client-side application that is cooperatively executed by one or more of client applications 22, 24, 26, 28 and/or collaboration application 20. As one or more of client applications 22, 24, 26, 28, transmission process 10, and collaboration application 20, taken singly or in any combination, may effectuate some or all of the same functionality, any description of effectuating such functionality via one or more of client applications 22, 24, 26, 28, transmission process 10, collaboration application 20, or combination thereof, and any described interaction(s) between one or more of client applications 22, 24, 26, 28, transmission process 10, collaboration application 20, or combination thereof to effectuate such functionality, should be taken as an example only and not to limit the scope of the disclosure.

Users 46, 48, 50, 52 may access computer 12 and transmission process 10 (e.g., using one or more of client electronic devices 38, 40, 42, 44) directly through network 14 or through secondary network 18. Further, computer 12 may be connected to network 14 through secondary network 18, as illustrated with phantom link line 54. Transmission process 10 may include one or more user interfaces, such as browsers and textual or graphical user interfaces, through which users 46, 48, 50, 52 may access transmission process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, and/or Bluetooth™ device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

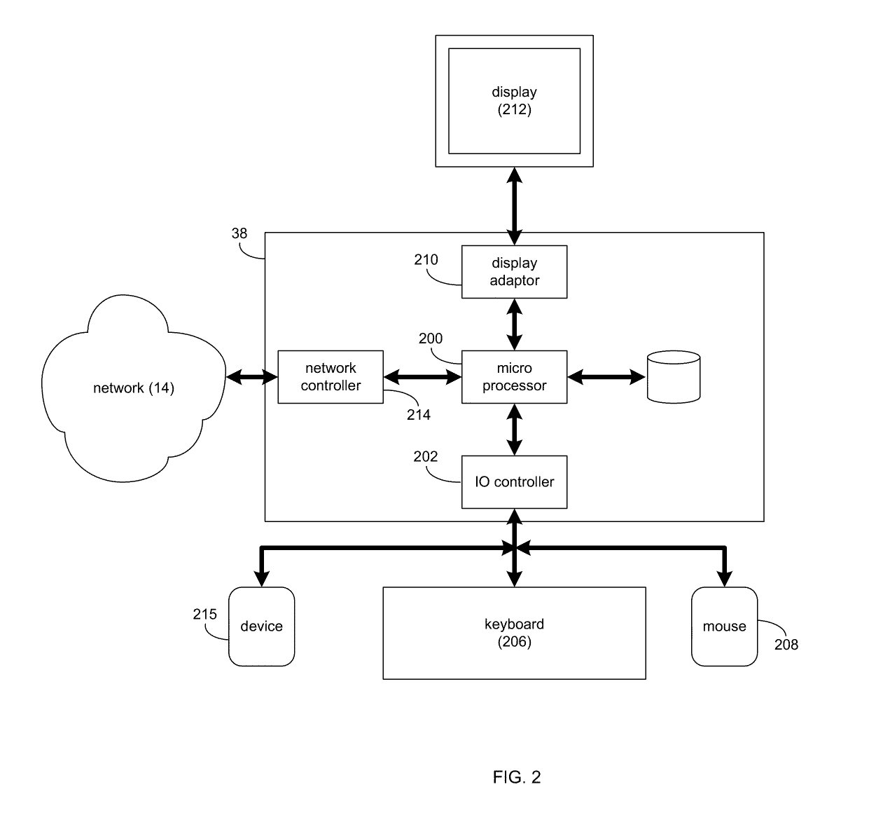

Referring also to FIG. 2, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, transmission process 10 may be substituted for client electronic device 38 within FIG. 2, examples of which may include but are not limited to computer 12 and/or client electronic devices 40, 42, 44.

Client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device(s) (e.g., storage device 30). An I/O controller (e.g., I/O controller 202) may be configured to couple microprocessor 200 with various devices, such as keyboard 206, pointing/selecting device (e.g., mouse 208), custom device (e.g., device 215), USB ports (not shown), and printer ports (not shown). A display adaptor (e.g., display adaptor 210) may be configured to couple display 212 (e.g., CRT or LCD monitor(s)) with microprocessor 200, while network controller/adaptor 214 (e.g., an Ethernet adaptor) may be configured to couple microprocessor 200 to the above-noted network 14 (e.g., the Internet or a local area network).

Generally, traditional Voice-Over-IP (VoIP) systems may have been built primarily around Peer to Peer (P2P) communication that may have been expected to run over stable broadband internet connections. An example advantage of P2P communication may be that it may not require mixing of audio packets or server interaction (e.g., in the general example case where the two endpoints may connect directly, enabling the service to scale well as it may only have to help facilitate the initial communication without further requirements from that point forward).

VoIP conferences may also include N endpoints (e.g., more than two computing devices in the communication session). Some VoIP systems may employ a mesh approach (e.g., where the client is built to handle N input streams). This example approach may be inefficient in terms of bandwidth and, as such, may not scale to large conferences. An alternative example approach may employ a hub-and-spoke model approach (e.g., where all endpoints may create a P2P connection with a central service). This service may be responsible for mixing input from all endpoints and producing a single output stream for each endpoint. This architecture may be more favorable in terms of bandwidth and may scale better for large conferences.

However, this example approach may, while mixing input, involve a CPU-intensive operation, as it may require decoding input from all N streams, and then re-encoding the output for all N streams. As such, it may be considered as prohibitively expensive to operate such a service. Common mixing architectures may not properly deal with jitter-prone network connections, which may be common particularly in a mobile environment. In the example case where an endpoint is sending media in a noisy, e.g., jittery or bursty manner, its data may not be properly mixed with other endpoints in a time-synchronized way, which may lead to a less than ideal experience for the user.

As will be discussed in greater detail below, transmission process 10 may implement an improved approach to mixing VoIP data from N endpoints (e.g., N computing devices) in a manner that may minimize CPU usage while mixing data from all endpoints in a proper time synchronized manner. In some implementations, the result may be a VoIP conferencing service (e.g., collaboration application 20) that better handles the highly variable network conditions experienced from computing devices (e.g., mobile computing device endpoints). Thus, transmission process 10 may yield a high quality voice stream as perceived by the end user, with minimal pops or other jitter that may be experienced in traditional mixing architectures. In some implementations, transmission process 10 may be executed such that most packets are sent out in the same time interval as they arrived on the service (e.g., the service via transmission process 10 may only be buffering when necessary and not inducing any extra latency).

As will be discussed in greater detail below, for each computing device endpoint, transmission process 10 may, e.g., track the next “expected” Real-time Transport Protocol (RTP) sequence and timestamp values. Rather than always delivering the next RTP packet available from a given endpoint (as may be done with traditional VoIP services), transmission process 10 may be implemented differently.

The Transmission Process:

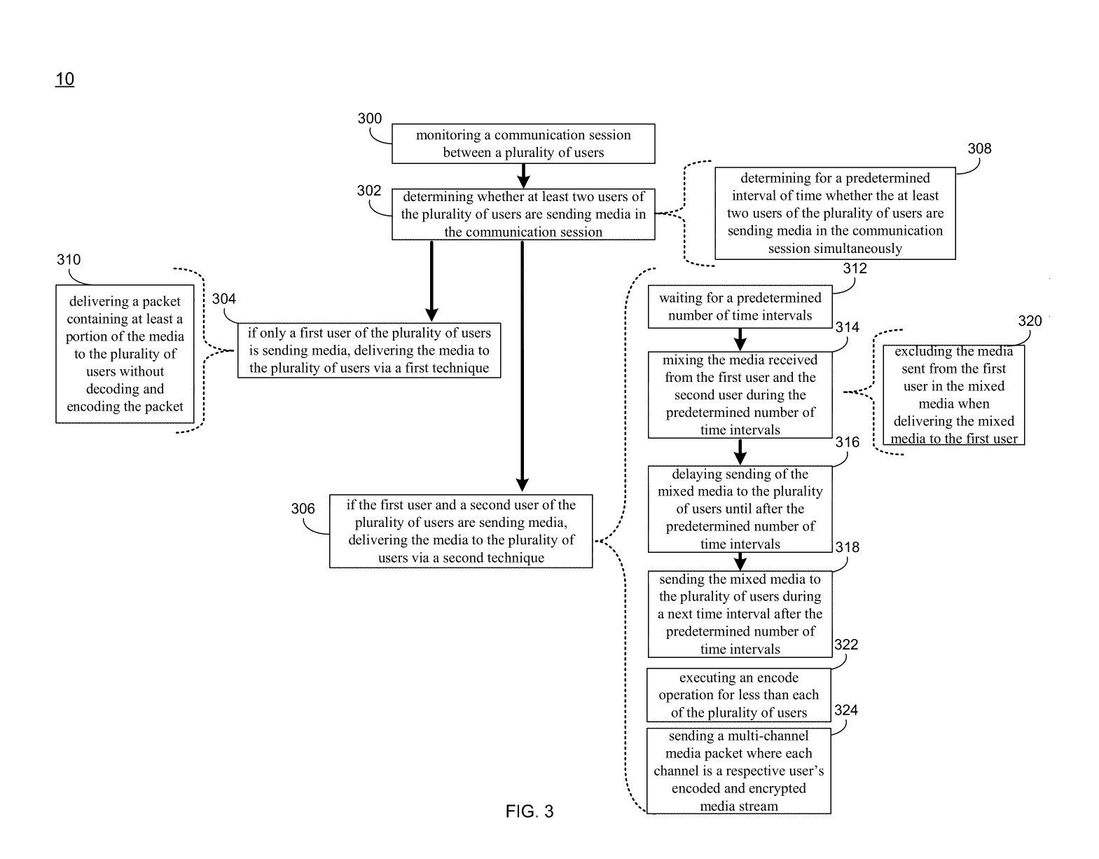

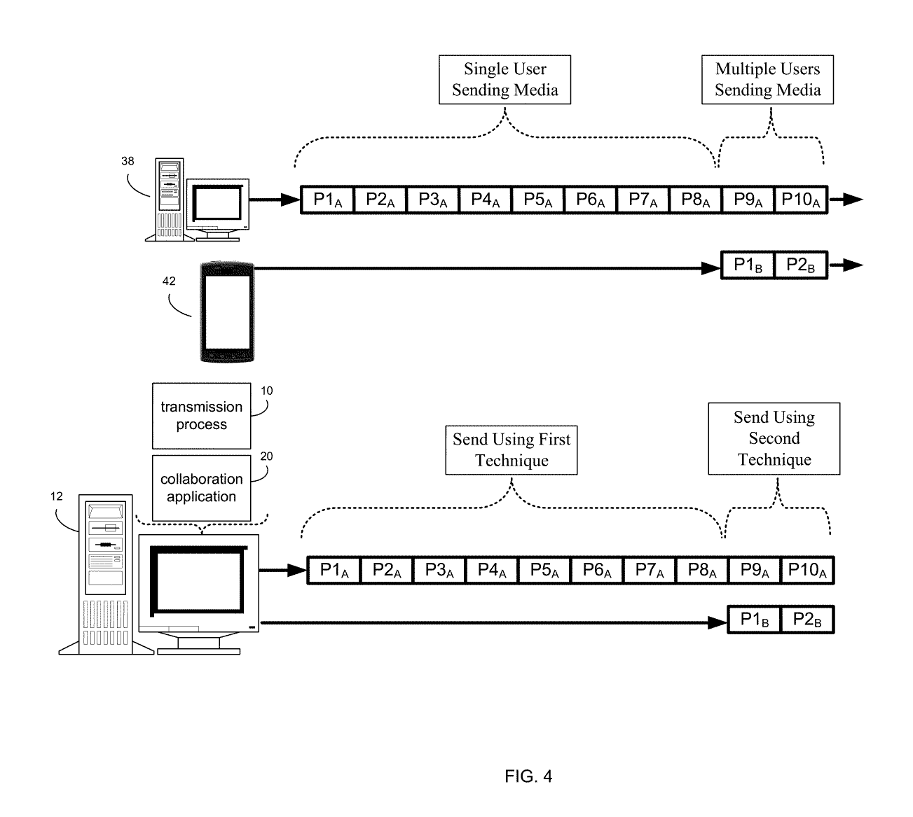

As discussed above and referring also at least to FIGS. 3-4, transmission process 10 may monitor 300 a communication session between a plurality of users. Transmission process 10 may determine 302 whether at least two users of the plurality of users are sending media in the communication session. If only a first user of the plurality of users is sending media, transmission process 10 may deliver 304 the media to the plurality of users via a first technique. If the first user and a second user of the plurality of users are sending media, transmission process 10 may deliver 306 the media to the plurality of users via a second technique.

Assume for example purposes only that a communication session (e.g., VoIP session) is implemented via, e.g., transmission process 10, collaboration application 20, client application(s), or combination thereof), between a plurality of users (e.g., users 46, 48, 50, and 52 via respective client electronic devices 38, 40, 42, and 44). In the example, media (e.g., audio and/or video data and/or other data/information) may be received from the users at a central computing device service (e.g., computer 12), similar to one or more aspects of the above-noted hub-and-spoke model approach (e.g., where one or more client electronic device endpoints may create a P2P connection with a central computing device service). In the example, transmission process 10 via computer 12 may be capable of receiving, mixing/synchronizing input (e.g., media input) from one or more endpoints (e.g., user's respective client electronic device) and producing a single output stream for each respective user's client electronic device. It will be appreciated that other approaches may be used without departing from the scope of the present disclosure. As such, the description of a similar hub-and-spoke model approach should be taken as an example only and not to limit the scope of the present disclosure.

In some implementations, transmission process 10 may monitor 300 a communication session between a plurality of users. For instance, transmission process 10 may monitor 300 the above-noted VoIP session between users 46, 48, 50, and 52 via respective client electronic devices 38, 40, 42, and 44. In some implementation, transmission process 10 may employ a Real-time Transport Protocol (or other example protocols as appropriate), that may be used by transmission process 10 to monitor 300 the VoIP session for, e.g., transmission statistics (such as timestamps for synchronization, sequence numbers for packet loss and reordering detection, payload format, etc.), quality of service information, etc.

In some implementations, transmission process 10 may determine 302 whether at least two users of the plurality of users are sending media in the communication session. For instance, transmission process 10 may use any of the above-noted information gathered while monitoring 300 the VoIP session to determine 302 which users of the plurality of users in the VoIP session may be sending media (e.g., speaking) and which users of the plurality of users in the VoIP session are not sending media (e.g., passive participants listening to the sent media but not speaking) For example, in some implementations, if transmission process 10 (e.g., via computer 12) is currently receiving media from a particular user (e.g., user 46) as a result of, e.g., user 46 speaking into a microphone of client electronic device 38, then transmission process 10 may determine 302 that user 46 is currently sending media (e.g., audio media). By contrast, if transmission process 10 (e.g., via computer 12) is not currently receiving media from user 46 as a result of, e.g., user 46 not speaking into the microphone of client electronic device 38, then transmission process 10 may determine 302 that user 46 is not currently sending media (e.g., audio media). In some implementations, transmission process 10 may apply a similar technique for each user participating in the VoIP session to determine 302 whether two or more users are sending media (e.g., audio and/or video media).

In some implementations, transmission process 10 may include signal analysis applications that may be able to distinguish between when user 46 is speaking, and when user 46 is not speaking. For example, assume that transmission process uses volume threshold signal analysis to determine 302 whether user 46 is currently sending media. For instance, if audio media sent from user 46 meets or exceeds the threshold volume, transmission process 10 may determine 302 that user 46 is sending media. Conversely, if audio media sent from user 46 does not meet or exceed the threshold volume, transmission process 10 may determine 302 that user 46 is not sending media. Continuing with the example, transmission process 10 may be able to use further signal analysis to distinguish between background noise reaching the volume threshold (such as a sneeze that may be confused with speech even when user 46 is not speaking) and actual speech when user 46 is speaking. It will be appreciated that other technique to determine 302 which users are sending media may be used without departing from the scope of the disclosure. In some implementations, the above-noted signal analysis need not require decoding of the media (packet), as metadata about volume levels may be packaged alongside the encoded media.

For example, in some implementations, determining 302 whether the at least two users of the plurality of users are sending media in the communication session may include transmission process 10 determining 308 for a predetermined interval of time whether the at least two users of the plurality of users are sending media in the communication session simultaneously. For instance, assume for example purposes only that the predetermined interval of time is, e.g., 20 ms. In the example, if transmission process 10 receives audio media from user 46 within 20 ms of receiving audio media from another user (e.g., user 50 via client electronic device 42), transmission process 10 may determine 308 that at least two users (e.g., users 46 and 50) are sending media simultaneously in the VoIP session. Conversely, if transmission process 10 receives audio media from user 46 after 20 ms of receiving the previous audio media from user 50, transmission process 10 may determine 308 that users 46 and 50 are not sending media simultaneously in the VoIP session. In some implementations, transmission process 10 may analyze the respective timestamps of the received media to make the above-noted determination 308. It will be appreciated that other techniques and/or intervals of time may be used without departing from the scope of the present disclosure. As such, the use analyzing timestamps and/or 20 ms intervals to make the above-noted determination 308 should be taken as an example only and not to limit the scope of the present disclosure. For example, in some implementation, if at time+20 ms transmission process 10 receives media from user 46, and then at +40 ms transmission process 10 receives media from sender 50, then transmission process 10 may determine 308 that users 46 and 50 are sending media simultaneously in the VoIP session and may wait before sending the media from user 50 to see if additional media is received from user 46. In the example, transmission process 10 may wait until either another media packet is received from user 46 or until it has been 100 ms (at time+120 ms). In some implementations, if at +20 ms transmission process 10 receives a media packet from user 46 and then at +140 ms receives a media packet from user 50, transmission process 10 may determine that user 46 is no longer speaking and immediately send the packet sent from user 50 on to the other users.

In some implementations, transmission process 10 may inspect the type of media packets being sent to make the above-noted determination whether the users are sending media. For instance, in some implementations, rather than not sending media when user 50 is not speaking, client electronic device 42 may send a type of packet called “comfort noise” (CN). Receiving a CN packet may be similarly equated with not receiving an actual media packet when determining whether user 50 is sending media.

In some implementations, if only a first user of the plurality of users is sending media, transmission process 10 may deliver 304 the media to the plurality of users via a first technique. For example, in some implementations, delivering 304 the media to the plurality of users via the first technique may include transmission process 10 delivering 310 a packet containing at least a portion of the media to the plurality of users without decoding and encoding the packet. For instance, and continuing with the above-example, further assume that only user 46 is determined 302 to be sending media in the VoIP session. In the example, based upon, at least in part, determining 302 that only user 46 is sending media, transmission process 10 may at computer 12 receive the packet containing at least some of the sent media from user 46, and may avoid decoding and/or encoding (and/or buffering) the packet. Traditionally, the media may arrive at computer 12 already encoded, where it may have been decoded, then re-encoded before sending it to the other users. However, in some implementations, for example, transmission process 10 may deliver 310 the packet to the users in the VoIP session directly, which may be similar to essentially transforming the VoIP session into a less CPU intensive one way “broadcast” (although receiving media from other users may still be possible). In the example, as a single speaker may cover a large majority of most conference calls, the “transformation” may reduce the number of encodes and decodes required by the mixing service portion of transmission process 10, and thus may increase its efficiency.

In some implementations, the media may be delivered to the first user and the second user via the first technique when only the first user and the second user are connected to the communication session. For example, transmission process 10 may include an optimization scenario where there are exactly two users (e.g., users 46 and 50) in the communication session and both are sending media. In this case, rather than decoding and mixing the data, transmission process 10 may send user 50's data to user 46 and vice-versa similarly to the above described first technique. This may allow transmission process 10 to reduce or avoid decoding and encoding.

In some implementations, if the first user and a second user of the plurality of users are sending media, transmission process 10 may deliver 306 the media to the plurality of users via a second technique. It will be appreciated that determining 302 whether one or more users are sending media (and thus determining which delivery 304/306 technique to apply) may be determined dynamically and on-the-fly. For instance, the media delivery technique may change at any time during the same VoIP session (and/or string of related media packets) between the same users. For example, and referring at least to FIG. 4, assume that user 46 is speaking and the associated media is received by transmission process 10 in the form of, e.g., 10 packets (P1_{A}-P10_{A}). In the example, further assume that user 46 is determined 302 to be the only speaker during the first 8 of 10 packets worth of user 46's media, and during the last two packets worth of user 46's media (e.g., packets P9_{A} and P10_{A}), user 50 simultaneously talks over user 46 with two packets worth of user 50's media (e.g., packets P1_{B} and P2_{B}) received by transmission process 10. Thus, in the example, it may be determined 302 that for packets P9_{A} and P10_{A} and P1_{B} and P2_{B}, more than one speaker is sending media. In the example, transmission process 10 may determine 302 that packets P1_{A}-P8_{A} may be delivered 304 from computer 12 to the plurality of users in the VoIP session using the first technique, while determining 302 that packets P9_{A} and P10_{A} and P1_{B} and P2_{B} may be delivered 306 from computer 12 to the plurality of users in the VoIP session using the second technique (described in greater detail below). As such, the techniques used to deliver 304/306 the media from the VoIP session may dynamically change between delivery techniques any number of times based upon, at least in part, the above-noted determination 302.

In some implementations, delivering 306 the media to the plurality of users via the second technique may include executing 322 an encode operation for less than each of the plurality of users. For example, assume the scenario where mixed media is being delivered to execute the smallest number of encodes possible. Traditionally, when mixing media for a plurality of users, systems may execute an encode operation for each of the users, regardless of whether or not the mixed media being sent to one or more of the users matches. By contrast, transmission process 10 may reduce this to the minimal number of encodes. For example, consider a scenario where there are 4 users (e.g., 46, 50, 52, and 48). Users 46 and 50 are producing media, and users 52 and 48 are not. In this example, transmission process 10 may execute 322 an encode operation for 3 different packets:

1. User 46 may be sent the media from user 50

2. User 50 may be sent the media from 46

3. Users 52 and 48 may be sent the mixed media from users 46 and 50, which is where transmission process 10 may save on resources. For example, previous systems may have encoded this packet twice (e.g., once for each user), however, transmission process 10 may only do it once. This allows transmission process 10 to limit the number of encodes to the number of user endpoints producing media+1 rather than the number of user endpoints connected to the communication session.

In some implementations, delivering 306 the media to the plurality of users via the second technique may include sending 324 a multi-channel media packet where each channel is a respective user's encoded and encrypted media stream. For example, transmission process 10 may provide for fully encrypting end-to-end communication by never decoding media on the conference service (e.g., at computer 12), regardless of the number of user endpoints producing media. For instance, transmission process 10 may send a multi-channel (e.g., mono, stereo, etc.) media packet, where each channel may be an individual user's encoded and encrypted media stream. In the example, each user (via their respective client electronic device) may have the information to decrypt and mix the media channels, but computer 12 may not.

In some implementations, delivering 306 the media to the plurality of users via the second technique may include transmission process 10 waiting 312 for a predetermined number of time intervals, and mixing 314 the media received from the first user and the second user during the predetermined number of time intervals. Transmission process 10 may delay 316 sending of the mixed media to the plurality of users until after the predetermined number of time intervals, and send 318 the mixed media to the plurality of users during a next time interval after the predetermined number of time intervals, where the mixed media sent 318 to the plurality of users in the next time interval may include a plurality of time intervals of media contained in a plurality of packets sent during a single time interval. In some implementations, waiting 312 for the predetermined number of time intervals may include waiting for zero time intervals.

For example, transmission process 10 may determine whether the next “expected” packet is available (e.g., not yet received or deemed to be lost) for all users determined 302 to be sending media. Such a determination may involve the monitoring 300/tracking of the next “expected” RTP sequence and timestamp values. In some implementations, if transmission process 10 determines that the next expected packet is not available as expected, transmission process 10 may wait 312 (e.g., sleep) for at least one predetermined time interval (e.g., 20 ms each) and then try again. In some implementations, transmission process 10 may wait 312 for a maximum number of time intervals, e.g., 5 predetermined number of time intervals (e.g., totaling 100 ms) before determining that the “next” packet is no longer expected (e.g., from either user). It will be appreciated that other time interval values and/or number of predetermined time intervals may be used without departing from the scope of the present disclosure. It will also be appreciated that the predetermined interval of time used to determine whether the at least two users of the plurality of users are sending media in the communication session simultaneously, need not be the same as the predetermined interval of time used when delaying the sending of the mixed media to the plurality of users. In some implementations, the intervals may be manually adjusted via a user interface (not shown) of transmission process 10. In some implementations, transmission process 10 may dynamically calculate the delay based upon the observed characteristics of the network connection.

Continuing with the above example, assume for example purposes only that transmission process 10 determines 302 that users 46 and 50 are currently sending media via client electronic devices 38 and 42 respectively. From time 0 to 4, further assume that user 46 sends one packet every time interval (e.g., 20 ms each) such that transmission process 10 receives (e.g., at computer 12) 4 packets of media from user 46. In the example, since transmission process 10 does not have the next expected packet from user 50 (e.g., while still within the 100 ms time interval(s)), transmission process 10 may continue to wait 312 and hold the 4 packets from user 46 and delay 316 sending them to the other users in the VoIP session. Further assume in the example that at time 5, transmission process 10 receives (e.g., at computer 12) 1 more packet from user 46 and 5 packets from user 50 (e.g., on a variable network connection). At this time (or after the 100 ms time interval), transmission process 10 may successfully mix 314/synchronize and send 318 packets 1-5, in order. Each user participating in the VoIP session may then receive 5 time intervals worth of data (e.g., media data) sent 318 from transmission process 10 via computer 12, and may play out (at their respective client electronic devices) a continuous stream of the media data from users 46 and 50 that is properly time-mixed.

In the example, by delaying 316 the sending of the packets from user 46, transmission process 10 may ensure that all packets received respectively from users 46 and 50 during the predetermined time interval(s), may be properly mixed using the appropriate packets, despite the subpar network connection of user 50. In some implementations, the delay may be as low as zero. In some implementations, the above approach may help compensate for the latency induced from user 50, by sending out all of the packets immediately, rather than one per time interval, which may double the latency. Thus, in some implementations, transmission process 10 may send 318 out packets as soon as they are ready (e.g., but does not typically do so before). As such, in some implementations, unlike traditional architectures, transmission process 10 may send 318 more than 1 time interval's worth of media data in a given time interval.

In some implementations, mixing 314 the media received from the first user and the second user may include excluding 320 the media sent from the first user in the mixed media when delivering the mixed media to the first user. For example, when transmission process 10 mixes 314 media, transmission process 10 may exclude 320 the sender's media from their outgoing packet. For example, if users 46, 50, and 52 are in the communication session and user 46 and 50 are producing media:

1. User 46 may be sent the media from user 50

2. User 50 may be sent the media from user 46

3. User 52 may be sent the mixed media from users 46 and 50.

This may ensure that each user does not hear an echo of themselves coming back.

It will be appreciated that while the disclosure describes implementations using audio media, any type of media (e.g., audio media, video media, or combination there), as well as any other types of data, may be used without departing from the scope of the disclosure. As such, the use of media (e.g., audio media) should be taken as an example only and not to limit the scope of the disclosure.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, and combinations thereof) are possible without departing from the scope of the disclosure defined in the appended claims.

What is claimed is:

1. A computer-implemented method comprising:
monitoring, by a computing device, a communication session between a plurality of users;
determining whether at least two users of the plurality of users are sending media in the communication session;
if only a first user of the plurality of users is sending media, delivering the media to the plurality of users via a first technique; and
if the first user and a second user of the plurality of users are sending media, delivering the media to the plurality of users via a second technique.

2. The computer-implemented method of claim 1 wherein determining whether the at least two users of the plurality of users are sending media in the communication session includes determining for a predetermined interval of time whether the at least two users of the plurality of users are sending media in the communication session simultaneously.

3. The computer-implemented method of claim 1 wherein delivering the media to the plurality of users via the first technique includes delivering a packet containing at least a portion of the media to the plurality of users without decoding and encoding the packet.

4. The computer-implemented method of claim 1 wherein delivering the media to the plurality of users via the second technique includes:
waiting for a predetermined number of time intervals; and
mixing the media received from the first user and the second user during the predetermined number of time intervals.

5. The computer-implemented method of claim 4 further comprising delaying sending of the mixed media to the plurality of users until after the predetermined number of time intervals.

6. The computer-implemented method of claim 5 further comprising sending the mixed media to the plurality of users during a next time interval after the predetermined number of time intervals.

7. The computer-implemented method of claim 6 wherein the mixed media sent to the plurality of users in the next time interval includes a plurality of time intervals of media contained in a plurality of packets sent during a single time interval.

8. The computer-implemented method of claim 4 wherein mixing the media received from the first user and the second user includes excluding the media sent from the first user in the mixed media when delivering the mixed media to the first user.

9. The computer-implemented method of claim 1 wherein the media is delivered to the first user and the second user via the first technique when only the first user and the second user are connected to the communication session.

10. The computer-implemented method of claim 1 wherein delivering the media to the plurality of users via the second technique includes executing an encode operation for less than each of the plurality of users.

11. The computer-implemented method of claim 1 wherein delivering the media to the plurality of users via the second technique includes sending a multi-channel media packet where each channel is a respective user's encoded and encrypted media stream.

12. A computer program product residing on a computer readable storage medium having a plurality of instructions stored thereon which, when executed by a processor, cause the processor to perform operations comprising:
monitoring a communication session between a plurality of users;
determining whether at least two users of the plurality of users are sending media in the communication session;
if only a first user of the plurality of users is sending media, delivering the media to the plurality of users via a first technique; and
if the first user and a second user of the plurality of users are sending media, delivering the media to the plurality of users via a second technique.

13. The computer program product of claim 12 wherein determining whether the at least two users of the plurality of users are sending media in the communication session includes determining for a predetermined interval of time whether the at least two users of the plurality of users are sending media in the communication session simultaneously.

14. The computer program product of claim 12 wherein delivering the media to the plurality of users via the first technique includes delivering a packet containing at least a portion of the media to the plurality of users without decoding and encoding the packet.

15. The computer program product of claim 12 wherein delivering the media to the plurality of users via the second technique includes:
waiting for a predetermined number of time intervals; and
mixing the media received from the first user and the second user during the predetermined number of time intervals.

16. The computer program product of claim 15 further comprising delaying sending of the mixed media to the plurality of users until after the predetermined number of time intervals.

17. The computer program product of claim 16 further comprising sending the mixed media to the plurality of users during a next time interval after the predetermined number of time intervals.

18. The computer program product of claim 17 wherein the mixed media sent to the plurality of users in the next time interval includes a plurality of time intervals of media contained in a plurality of packets sent during a single time interval.

19. The computer program product of claim 15 wherein mixing the media received from the first user and the second user includes excluding the media sent from the first user in the mixed media when delivering the mixed media to the first user.

20. The computer program product of claim 12 wherein the media is delivered to the first user and the second user via the first technique when only the first user and the second user are connected to the communication session.

21. The computer program product of claim 12 wherein delivering the media to the plurality of users via the second technique includes executing an encode operation for less than each of the plurality of users.

22. The computer program product of claim 12 wherein delivering the media to the plurality of users via the second technique includes sending a multi-channel media packet where each channel is a respective user's encoded and encrypted media stream.

23. A computing system including a processor and a memory configured to perform operations comprising:
monitoring a communication session between a plurality of users;
determining whether at least two users of the plurality of users are sending media in the communication session;
if only a first user of the plurality of users is sending media, delivering the media to the plurality of users via a first technique; and
if the first user and a second user of the plurality of users are sending media, delivering the media to the plurality of users via a second technique.

24. The computing system of claim 23 wherein determining whether the at least two users of the plurality of users are sending media in the communication session includes determining for a predetermined interval of time whether the at least two users of the plurality of users are sending media in the communication session simultaneously.

25. The computing system of claim 23 wherein delivering the media to the plurality of users via the first technique includes delivering a packet containing at least a portion of the media to the plurality of users without decoding and encoding the packet.

26. The computing system of claim 23 wherein delivering the media to the plurality of users via the second technique includes:
waiting for a predetermined number of time intervals; and
mixing the media received from the first user and the second user during the predetermined number of time intervals.

27. The computing system of claim 26 further comprising delaying sending of the mixed media to the plurality of users until after the predetermined number of time intervals.

28. The computing system of claim 27 further comprising sending the mixed media to the plurality of users during a next time interval after the predetermined number of time intervals.

29. The computing system of claim 28 wherein the mixed media sent to the plurality of users in the next time interval includes a plurality of time intervals of media contained in a plurality of packets sent during a single time interval.

30. The computing system of claim 26 wherein mixing the media received from the first user and the second user includes excluding the media sent from the first user in the mixed media when delivering the mixed media to the first user.

31. The computing system of claim 23 wherein the media is delivered to the first user and the second user via the first technique when only the first user and the second user are connected to the communication session.

32. The computing system of claim 23 wherein delivering the media to the plurality of users via the second technique includes executing an encode operation for less than each of the plurality of users.

33. The computing system of claim 23 wherein delivering the media to the plurality of users via the second technique includes sending a multi-channel media packet where each channel is a respective user's encoded and encrypted media stream.
